(19) United States
(12) Patent Application Publication
(10) Pub. No.: US 2017/0038454 A1
(43) Pub. Date: Feb. 9, 2017

(54) METHOD AND SYSTEM FOR ESTIMATING SIGNAL GENERATION POSITION BASED ON SIGNAL STRENGTH

(71) Applicant: Electronics and Telecommunications Research Institute, Daejeon (KR)

(72) Inventors: Keun Young KIM, Anyang-si Gyeonggi-do (KR); Yeong Jin KIM, Daejeon (KR); Seung Chan BANG, Daejeon (KR); Moon Sik LEE, Daejeon (KR); Sang Ho LEE, Daejeon (KR); Jun Hwan LEE, Seoul (KR)

(21) Appl. No.: 15/229,324

(22) Filed: Aug. 5, 2016

(30) Foreign Application Priority Data
Aug. 5, 2015 (KR) 10-2015-0110557

(51) Int. Cl. G01S 3/781; G01S 3/801

(52) U.S. Cl. CPC G01S 3/781; G01S 3/801

(57) ABSTRACT

Provided is a method for estimating a signal generation position based on signal strength, including: measuring a first signal strength which is a strength of a signal propagated from a generation position of the signal at a first measurement point; measuring a second signal strength which is a strength of the signal propagated from the generation position of the signal at a second measurement point distinguished from the first measurement point; calculating an attenuation constant of a medium to which the signal is propagated from the generation position up to the first measurement point and the second measurement point; and estimating the generation position by using the first signal strength, the second signal strength, and the attenuation constant, wherein the first measurement point, the second measurement point, and the generation position are present on one straight line. This method can be extended to estimate a signal generation point in 2D plane or 3D space.

### CROSS-REFERENCE TO RELATED APPLICATIONS

This application claims priority to and the benefit of Korean Patent Application No. 10-2015-0110557 filed in the Korean Intellectual Property Office on Aug. 5, 2015, the entire contents of which are incorporated herein by reference.

### TECHNICAL FIELD

The present invention relates to a method for estimating a signal generation position based on a signal strength, and more particularly, which estimates a source of a signal by using a strength and an attenuation constant of the signal.

### BACKGROUND ART

Signals such as sound and light waves are propagated in all directions through a medium such as a solid, a liquid, gas, or vacuum. In addition, propagation characteristics of the signals such as the sound and light waves vary according to a characteristic of the corresponding medium.

In general, it is difficult and impossible to know a magnitude of a signal of a source where the signal is generated and it is not easy to determine transfer characteristics of the signals propagated through not a free space but various media including the solid, the liquid, and the gas. Moreover, the propagation characteristics of the signals may vary depending on various external requirements including a temperature and an obstacle of a path through which the signals are transferred.

### SUMMARY OF THE INVENTION

The present invention has been made in an effort to provide a method for estimating a signal generation position based on a signal strength, which estimates a generation position of a corresponding signal by using an attenuation constant and a measured strength of the signal without determining a detailed propagation characteristic of a medium to which the signal is propagated.

An exemplary embodiment of the present invention provides a method for estimating a signal generation position in 1-dimensional space based on a signal strength, including: measuring a first signal strength which is a strength of a signal propagated from a generation position of the signal at a first measurement point; measuring a second signal strength which is a strength of the signal propagated from the generation position of the signal at a second measurement point distinguished from the first measurement point; calculating an attenuation constant of a medium to which the signal is propagated from the generation position up to the first measurement point and the second measurement point; and estimating the generation position by using the first signal strength, the second signal strength, and the attenuation constant, wherein the first measurement point, the second measurement point, and the generation position are present on one straight line.

When the generation position is x, the first measurement point is x1, the second measurement point is x2, the first signal strength is a, the second signal strength is b, and the attenuation constant is α, the x, x1, x2, a, b, and a may satisfy an equation given below;

|x−x1|:|x2−x|=1/a^{α}:1/b^{α}.

Another exemplary embodiment of the present invention provides a method for estimating a signal generation position in 2-dimensional space based on a signal strength, including: measuring a first signal strength which is a strength of a signal propagated from a generation position of the signal at a first measurement point; measuring a second signal strength which is a strength of the signal propagated from the generation position of the signal at a second measurement point distinguished from the first measurement point; measuring a third signal strength which is the strength of the signal propagated from the generation position of the signal at a third measurement point distinguished from the first measurement point and the second measurement point and not positioned on a straight line linking the first measurement point and the second measurement point; calculating an attenuation constant of a medium to which the signal is propagated from the generation position up to the first measurement point, the second measurement point, and the third measurement point; and estimating the generation position by using the first signal strength, the second signal strength, the third signal strength, and the attenuation constant.

When the generation position is x, the first measurement point is x1, the second measurement point is x2, the third measurement point is x3, the first signal strength is a, the second signal strength is b, the third signal strength is c, and the attenuation constant is α, the x, x1, x2, x3, a, b, c, and a may satisfy two equations given below;

|x−x1|:|x2−x|=1/a^{α}:1/b^{α}

|x−x1|:|x3−x|=1/a^{α}:1/c^{α}

Yet another exemplary embodiment of the present invention provides a method for estimating a signal generation position in 3-dimensional space based on a signal strength, including: measuring a first signal strength which is a strength of a signal propagated from a generation position of the signal at a first measurement point; measuring a second signal strength which is a strength of the signal propagated from the generation position of the signal at a second measurement point distinguished from the first measurement point; measuring a third signal strength which is the strength of the signal propagated from the generation position of the signal at a third measurement point distinguished from the first measurement point and the second measurement point and not positioned on a straight line linking the first measurement point and the second measurement point; measuring a fourth signal strength which is the strength of the signal propagated from the generation position of the signal at a fourth measurement point distinguished from the first measurement point, the second measurement point, and the third measurement point and not positioned on the plane linking the first measurement point, the second measurement point and the third measurement point; calculating an attenuation constant of a medium to which the signal is propagated from the generation position up to the first measurement point, the second measurement point, the third measurement point, and the fourth measurement point; and estimating the generation position by using the first signal strength, the second signal strength, the third signal strength, the fourth signal strength, and the attenuation constant.

When the generation position is x, the first measurement point is x1, the second measurement point is x2, the third measurement point is x3, the fourth measurement point is x4, the first signal strength is a, the second signal strength is b, the third signal strength is c, the fourth signal strength is d, and the attenuation constant is α, the x, x1, x2, x3, x4, a, b, c, d, and a may satisfy three equations given below;

|x−x1|:|x2−x|=1/a^{α}:1/b^{α}

|x−x1|:|x3−x|=1/a^{α}:1/c^{α}

|x−x1|:|x4−x|=1/a^{α}:1/d^{α}.

According to exemplary embodiments of the present invention, a method for estimating a signal generation position based on a signal strength can estimate a generation position of a corresponding signal by using an attenuation constant and a measured strength of the signal without determining a detailed propagation characteristic of a medium to which the signal is propagated.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a method for estimating a generation position where a signal is generated in the case of a straight line according to an exemplary embodiment of the present invention.

FIG. 2 is a diagram illustrating a method for estimating a generation position where a signal is generated in the case of a plane according to another exemplary embodiment of the present invention.

FIG. 3 is a diagram illustrating a method for estimating a generation position where a signal is generated in the case of a space according to yet another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The advantages and features of the present invention and methods of accomplishing them will be described through exemplary embodiments to be described below in detail along with the accompanying drawings. However, the present invention is not limited to exemplary embodiments described herein and may be embodied in other forms. However, the exemplary embodiments are provided to be described in detail to those skilled in the art so as to easily execute the technical spirit of the present invention.

In drawings, the exemplary embodiments of the present invention are not limited to an illustrated specific form and are exaggerated for clarity. Specific terms are used in the present specification, but the specific terms are used for describing the present invention and not used to limit a meaning or limit the scope of the present invention disclosed in the claims.

In the specification, an expression of ‘and/or’ is used as a meaning including at least one of components arranged front and rear. Further, an expression of ‘connected/coupled’ is used as a meaning including directly connected with another component or indirectly connected through another component. Unless particularly stated otherwise in phrases of the present specification, a singular form also includes a plural form. Further, the meaning of “comprises” or “comprising” used in this specification for the aforementioned constituent elements, steps, operations, and devices does not exclude the existence or addition of one or more other constituent elements, steps, operations, and devices.

Hereinafter, exemplary embodiments of the present invention will be described in detail with reference to the accompanying drawings.

When a strength of a signal among propagation characteristics of the signal is described, in the case where a medium to which the signal is propagated is a free space, the signal is propagated in all directions while the strength of the propagated signal is in inverse proportion to a square of a propagation distance of the signal. Therefore, when a transfer characteristic of a propagation depending on the medium to which the corresponding signal is propagated is known, in the case where the strength of the corresponding signal, which is measured at a place where the signal is sensed and a characteristic of the medium to which the signal is propagated are known, a position where the corresponding signal is generated may be estimated. That is, in the case of the free space, since a magnitude of the signal decreases in proportion to the square of the distance, when the magnitude of the generated signal is known, the position may be estimated by using a difference from the measured signal.

According to the present invention, strengths of signals sensed at multiple positions may be measured according to a characteristic of a 2D or 3D space and the generation position where the corresponding signal is generated may be estimated by using only the attenuation constant of the medium to which the corresponding signal is propagated. Further, according to the present invention, in addition to the case where the medium to which the signal is propagated is gas, in the case where the medium is a liquid, the strength of the signal may be measured by using an underwater hydrophone, and as a result, the generation position of the signal may be estimated and in the case where the medium is a solid, the generation position may be similarly estimated.

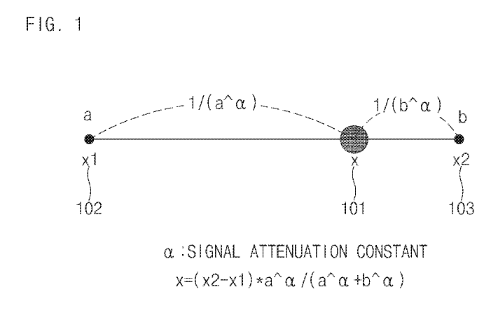

FIG. 1 is a diagram illustrating a method for estimating a generation position where a signal is generated in the case of a straight line according to an exemplary embodiment of the present invention.

Referring to FIG. 1, a first measurement point 102 and a second measurement point 103 which are places where a strength of a propagated signal is measured are x1 and x2, respectively and a source position of the corresponding signal is x. In addition, a first signal strength and a second signal strength which are strengths of the signals measured at the first measurement point 102 and the second measurement point 103 are a and b, respectively.

First, the first signal strength ‘a’ which is a strength of a signal propagated from a generation position 101 of the corresponding signal to the first measurement point 102 is measured at the first measurement point 102 and the second signal strength ‘b’ which is a strength of a signal propagated from the generation position 101 of the corresponding signal to the second measurement point 103 is measured at the second measurement point 103. Herein, the second measurement point 103 is a separate measurement point distinguished from the first measurement point 102. Further, the first measurement point 102, the second measurement point 103, and the generation position 101 are preferably positioned on one straight line.

Thereafter, an attenuation constant α of a medium to which the corresponding signal is propagated from the generation position 101 to the first measurement point 102 and the second measurement point 103 is calculated. Herein, the signals measured at the first measurement point 102 and the second measurement point 103 are preferably propagated through the same medium.

Thereafter, the generation position 101 of the corresponding signal is estimated by using the first signal strength a, the second signal strength b, and the attenuation constant α. Contents in which the generation position 101 of the signal is estimated are described together with a more detailed example.

When the corresponding signals generated from the generation position 101 are propagated through the same medium to the first measurement point 102 and the second measurement point 103, and are measured at the first measurement point 102 and the second measurement point 103, the corresponding signals have the same propagation characteristic. Herein, when it is assumed that the attenuation constant α of the corresponding medium is 2, the generation position may be calculated by considering that the signal is originated at a position at which the signal strength is in inverse proportion to a square (attenuation constant α) of the measured first signal strength a and second signal strength b.

That is, since a ratio of the strengths of the signals measured at the first measurement point 102 and the second measurement point 103 is a:b, the generation position 101 of the corresponding signal may be calculated as being present at a point of 1/(a*a):1/(b*b) on the straight line linking the first measurement point 102, the second measurement point 103, and the generation position 101. When the first signal strength ‘a’ measured at the first measurement point x1; 102 is 1 and the second signal strength ‘b’ measured at the second measurement point x2; 103 is 2, the generation position x; 101 of the corresponding signal corresponds to a position of 1:1/4 of the first measurement point x1; 102 and the second measurement point x2; 103.

When this is generalized and described, the generation position x of the corresponding signal, the first measurement point x1, the second measurement point x2, the first signal strength a, the second signal strength b, and the attenuation constant α satisfy Equation 1 given below.

|x−x1|:|x2−x|=1/a^{α}:1/b^{α} [Equation 1]

Here, |x| means a distance (L2 norm) of x. Further, since x is expressed as one unknown number on the straight line and the number of equations is one, a resolution of the equation may be generally acquired.

Up to this point, the generation position of the signal and the measurement position where the strength of the propagated signal is measured are present on one straight line and the generation position of the signal may be estimated by a similar method even on a 2D plane.

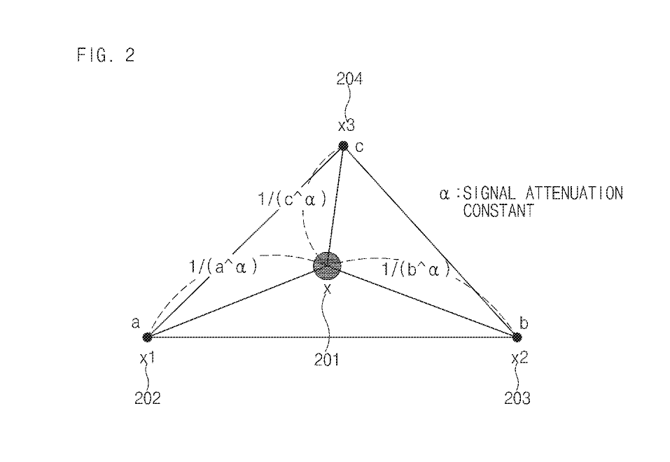

FIG. 2 is a diagram illustrating a method for estimating a generation position where a signal is generated in the case of a plane according to another exemplary embodiment of the present invention.

Referring to FIG. 2, a first measurement point 202, a second measurement point 203, and a third measurement point 204 which are the places where the strength of the propagated signal is measured are x1, x2, and x3, respectively and the source position of the corresponding signal is x. In addition, a first signal strength, a second signal strength, and a third signal strength which are strengths of the signals measured at the first measurement point 202, the second measurement point 203, and the third measurement point 204 are a, b, and c, respectively.

First, the first signal strength ‘a’ which is a strength of a signal propagated from a generation position 201 of the corresponding signal to the first measurement point 202 is measured at the first measurement point 202, the second signal strength ‘b’ which is a strength of a signal propagated from the generation position 201 of the corresponding signal to the second measurement point 203 is measured at the second measurement point 203, and the third signal strength ‘c’ which is a strength of a signal propagated from the generation position 201 of the corresponding signal to the third measurement point 204 is measured at the third measurement point 204. Herein, the second measurement point 203 is a separate measurement point distinguished from the first measurement point 202 and the third measurement point 204 is distinguished from the first measurement point 202 and the second measurement point 203 and is not positioned on a straight line linking the first measurement point 202 and the second measurement point 203.

Thereafter, the attenuation constant α of the medium to which the corresponding signal is propagated from the generation position 201 to the first measurement point 202, the second measurement point 203, and the third measurement point 204 is calculated. Herein, the signals measured at the first measurement point 202, the second measurement point 203, and the third measurement point 204 are preferably propagated through the same medium.

Thereafter, the generation position 201 of the corresponding signal is estimated by using the first signal strength a, the second signal strength b, the third signal strength c, and the attenuation constant α. Contents in which the generation position 201 of the signal is estimated are described together with a more detailed example.

When the corresponding signals generated from the generation position 201, are propagated through the same medium to the first measurement point 202, the second measurement point 203, and the third measurement point 204, and are measured at the first measurement point 202, the second measurement point 203, and the third measurement point 204, the corresponding signals have the same propagation characteristic. Herein, when it is assumed that the attenuation constant α of the corresponding medium is 2, the generation position may be calculated by considering that the signal is originated at a position at which the signal strength is in inverse proportion to a square (attenuation constant; a) of the measured first signal strength a, second signal strength b, and third signal strength c.

That is, the ratio of the strengths of the signals measured at the first measurement point 202 and the second measurement point 203 is a:b and the ratio of the strengths of the signals measured at the first measurement point 202 and the third measurement point 204 is a:c. Accordingly, the generation position 101 of the corresponding signal may be calculated to be present at the point of 1/(a*a):1/(b*b) in a relationship of the first measurement point 202 and the second measurement point 203 and calculated to be present at a point of 1/(a*a):1/(c*c) in a relationship of the first measurement point 202 and the third measurement point 204.

Consequently, the generation position x of the corresponding signal, the first measurement point x1, the second measurement point x2, the third measurement point x3, the first signal strength a, the second signal strength b, the third signal strength c, and the attenuation constant α satisfy Equations 2 and 3 given below.

|x−x1|:|x2−x|=1/a^{α}:1/b^{α} [Equation 2]

|x−x1|:|x3−x|=1/a^{α}:1/b^{α} [Equation 3]

Here, |x| means the distance (L2 norm) of x. Further, since x is expressed as two unknown numbers on the plane and the number of equations is two, a resolution of the equation may be generally acquired.

Up to this point, the generation position of the signal and the measurement position where the strength of the propagated signal is measured are present on a 2D plane and the generation position of the signal may be estimated by a similar method even on a 3D space.

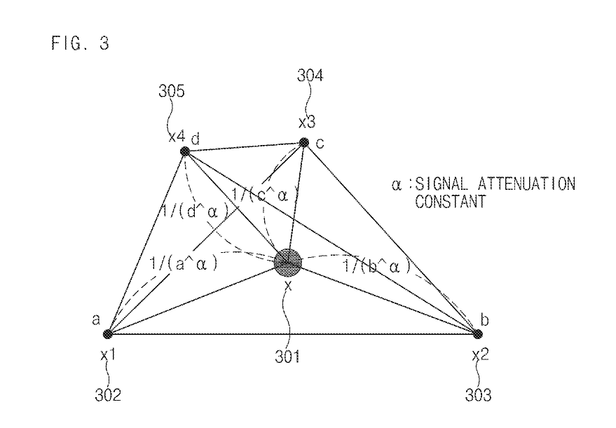

FIG. 3 is a diagram illustrating a method for estimating a generation position where a signal is generated in the case of a space according to yet another exemplary embodiment of the present invention.

Referring to FIG. 3, a first measurement point 302, a second measurement point 303, and a third measurement point 304, and a fourth measurement point 305 which are the places where the strength of the propagated signal is measured are x1, x2, x3, and x4 respectively and the source position of the corresponding signal is x. In addition, a first signal strength, a second signal strength, a third signal strength, and a fourth signal strength which are strengths of the signals measured at the first measurement point 302, the second measurement point 303, the third measurement point 304, and the fourth measurement point 305 are a, b, c, and d, respectively.

First, the first signal strength ‘a’ which is a strength of a signal propagated from a generation position 301 of the corresponding signal to the first measurement point 302 is measured at the first measurement point 302, the second signal strength ‘b’ which is a strength of a signal propagated from the generation position 301 of the corresponding signal to the second measurement point 303 is measured at the second measurement point 303, the third signal strength ‘c’ which is a strength of a signal propagated from the generation position 301 of the corresponding signal to the third measurement point 304 is measured at the third measurement point 304, and the fourth signal strength ‘d’ which is a strength of a signal propagated from the generation point 301 of the corresponding signal up to the fourth measurement point 305 is measured at the fourth measurement point 305. Herein, the second measurement point 303 is a separate measurement point distinguished from the first measurement point 302, the third measurement point 304 is distinguished from the first measurement point 302 and the second measurement point 303 and is not positioned on a straight line linking the first measurement point 302 and the second measurement point 303. Similarly, the fourth measurement point 305 is distinguished from the first, second and third measurement points 302, 303, 304 and is not positioned on a plane linking the first, second and third measurement points.

Thereafter, the attenuation constant α of the medium to which the corresponding signal is propagated from the generation position 301 to the first measurement point 302, the second measurement point 303, the third measurement point 304, and the fourth measurement point 305 is calculated. Herein, the signals measured at the first measurement point 302, the second measurement point 303, the third measurement point 304, and the fourth measurement point 305 are preferably propagated through the same medium.

Thereafter, the generation position 301 of the corresponding signal is estimated by using the first signal strength a, the second signal strength b, the third signal strength c, the fourth signal strength d, and the attenuation constant α. Contents in which the generation position 301 of the signal is estimated are described together with a more detailed example.

When the corresponding signals generated from the generation position 301 are propagated through the same medium to the first measurement point 302, the second measurement point 303, the third measurement point 304, and the fourth measurement point 305, and are measured at the first measurement point 302, the second measurement point 303, the third measurement point 304, and the fourth measurement point 305, the corresponding signals have the same propagation characteristic. Herein, when it is assumed that the attenuation constant α of the corresponding medium is 2, the generation position may be calculated by considering that the signal is originated at a position at which the signal strength is in inverse proportion to a square (attenuation constant; α) of the measured first signal strength a, second signal strength b, third signal strength c, and fourth signal strength d.

That is, the ratio of the strengths of the signals measured at the first measurement point 302 and the second measurement point 303 is a:b, the ratio of the strengths of the signals measured at the first measurement point 302 and the third measurement point 304 is a:c, and the ratio of the strengths of the signals measured at the first measurement point 302 and the fourth measurement point 305 is a:d. Accordingly, the generation position 301 of the corresponding signal may be calculated to be present at the point of 1/(a*a):1/(b*b) in the relationship of the first measurement point 302 and the second measurement point 303, calculated to be present at the point of 1/(a*a):1/(c*c) in the relationship of the first measurement point 302 and the third measurement point 304, and calculated to be present at a point of 1/(a*a):1/(d*d) in a relationship of the first measurement point 302 and the fourth measurement point 305.

Consequently, the generation position x of the corresponding signal, the first measurement point x1, the second measurement point x2, the third measurement point x3, the fourth measurement point x4 the first signal strength a, the second signal strength b, the third signal strength c, the fourth signal strength d, and the attenuation constant α satisfy Equations 4, 5, and 6 given below.

|x−x1|:|x2−x|=1/a^{α}:1/b^{α} [Equation 4]

|x−x1|:|x3−x|=1/a^{α}:1/c^{α} [Equation 5]

|x−x1|:|x4−x|=1/a^{α}:1/d^{α} [Equation 6]

Here, |x| means the distance (L2 norm) of x. Further, since x is expressed as three unknown numbers on the space and the number of equations is three, a resolution of the equation may be generally acquired.

The strength of the signal described above may be a mean signal strength obtained by averaging signal strengths measured for a predetermined time.

Consequently, in the method for estimating a signal generation position based on a signal strength according to the exemplary embodiment of the present invention, without determining a detailed propagation characteristic depending on a medium, signal strengths may be measured at two measurement points in order to determine a generation position on a straight line, signal strengths may be measured at three measurement points in order to determine the generation position on a plane, and signal strengths may be measured at four measurement points in order to determine the generation position in a space, and the generation position where the signal is generated may be estimated by applying an attenuation constant depending on the medium together therewith.

Hereinabove, the present invention has been described through the detailed exemplary embodiments, but it will be well appreciated that various modifications can be made without departing from the scope of the present invention. Therefore, the scope of the present invention should not be limited to the exemplary embodiment and should be defined by the appended claims and equivalents to the appended claims. By considering the aforementioned contents, if modifications and changes of the present invention are included in the appended claims and the scope of the equivalent thereto, it is regarded that the present invention includes the changes and modifications of the present invention.

What is claimed is:

1. A method for estimating a signal generation position based on a signal strength, the method comprising:
measuring a first signal strength which is a strength of a signal propagated from a generation position of the signal at a first measurement point;
measuring a second signal strength which is a strength of the signal propagated from the generation position of the signal at a second measurement point distinguished from the first measurement point;
calculating an attenuation constant of a medium to which the signal is propagated from the generation position up to the first measurement point and the second measurement point; and
estimating the generation position by using the first signal strength, the second signal strength, and the attenuation constant,
wherein the first measurement point, the second measurement point, and the generation position are present on one straight line.

2. The method of claim 1, wherein when the generation position is x,
the first measurement point is x1,
the second measurement point is x2,
the first signal strength is a,
the second signal strength is b, and
the attenuation constant is α,
the x, x1, x2, a, b, and α satisfy an equation given below.

|x−x1|:|x2−x|=1/a^{α}:1/b^{α}

3. A method for estimating a signal generation position based on a signal strength, the method comprising:
measuring a first signal strength which is a strength of a signal propagated from a generation position of the signal at a first measurement point;
measuring a second signal strength which is a strength of the signal propagated from the generation position of the signal at a second measurement point distinguished from the first measurement point;
measuring a third signal strength which is the strength of the signal propagated from the generation position of the signal at a third measurement point distinguished from the first measurement point and the second measurement point and not positioned on a straight line linking the first measurement point and the second measurement point;
calculating an attenuation constant of a medium to which the signal is propagated from the generation position up to the first measurement point, the second measurement point, and the third measurement point; and
estimating the generation position by using the first signal strength, the second signal strength, the third signal strength, and the attenuation constant.

4. The method of claim 3, wherein when the generation position is x,
the first measurement point is x1,
the second measurement point is x2,
the third measurement point is x3,
the first signal strength is a,
the second signal strength is b,
the third signal strength is c, and
the attenuation constant is α,
the x, x1, x2, x3, a, b, c, and α satisfy two equations given below.

|x−x1|:|x2−x|=1/a^{α}:1/b^{α}

|x−x1|:|x3−x|=1/a^{α}:1/c^{α}

5. A method for estimating a signal generation position based on a signal strength, the method comprising:
measuring a first signal strength which is a strength of a signal propagated from a generation position of the signal at a first measurement point;
measuring a second signal strength which is a strength of the signal propagated from the generation position of the signal at a second measurement point distinguished from the first measurement point;
measuring a third signal strength which is the strength of the signal propagated from the generation position of the signal at a third measurement point distinguished from the first measurement point and the second measurement point and not positioned on a straight line linking the first measurement point and the second measurement point;
measuring a fourth signal strength which is the strength of the signal propagated from the generation position of the signal at a fourth measurement point distinguished from the first measurement point, the second measurement point, and the third measurement point and not positioned on the straight line linking the first measurement point and the second measurement point;
calculating an attenuation constant of a medium to which the signal is propagated from the generation position up to the first measurement point, the second measurement point, the third measurement point, and the fourth measurement point; and
estimating the generation position by using the first signal strength, the second signal strength, the third signal strength, the fourth signal strength, and the attenuation constant.

6. The method of claim 5, wherein when the generation position is x,
the first measurement point is x1,
the second measurement point is x2,
the third measurement point is x3,
the fourth measurement point is x4,
the first signal strength is a,
the second signal strength is b,
the third signal strength is c,
the fourth signal strength is d, and
the attenuation constant is α,
the x, x1, x2, x3, x4, a, b, c, d, and α satisfy three equations given below.

|x−x1|:|x2−x|=1/a^{α}:1/b^{α}

|x−x1|:|x3−x|=1/a^{α}:1/c^{α}

|x−x1|:|x4−x|=1/a^{α}:1/d^{α}
